(19) United States
(12) Patent Application Publication
(10) Pub. No.: US 2018/0335018 A1
(43) Pub. Date: Nov. 22, 2018

(54) Turbine Loads Determination and Condition Monitoring

(71) Applicant: Frontier Wind, LLC, West Conshohocken, PA (US)

(72) Inventors: Nannan Cao, Albuquerque, NM (US); Jeffrey Austin Butterworth, Longmont, CO (US); Jonathon Paul Baker, Roseville, CA (US); Guojian Lin, West Sacramento, CA (US); Myron Floyd Miller, West Conshohocken, PA (US)

(21) Appl. No.: 15/596,538

(22) Filed: May 16, 2017

(51) Int. Cl. F03D 7/04; F03D 7/02; G05B 13/02

(52) U.S. Cl. CPC F03D 7/046; F03D 7/0224; F05B 2270/709; G05B 13/027; F05B 2240/221; F03D 7/0236

(57) ABSTRACT

Systems and methods for determining turbine pressure related loads and for condition monitoring are provided. The systems and methods may measure at least one pressure differential on an airfoil. At least one pressure differential may be used to determine a root bending moment associated with the blade. Additionally or alternatively, at least one pressure differential may be used to determine a low-speed shaft moment for a turbine on which the blade is mounted. Still further, at least one pressure differential and/or moment may be used to gauge wear/fatigue and/or damage to one or more wind turbines. Based on this information, a controller may modify various operating characteristics of the turbine or blade to address the fatigue or damage.

### TECHNICAL FIELD

Aspects of the present disclosure relate to determining loads and moments of blades on a wind turbine.

### BACKGROUND

Measurement of loads in mechanical and electronic devices is often used to optimize performance. Excessive loads may strain the system and result in damage or lower efficiency. In the aerodynamics field, for example, blades or wings may be susceptible to excess loads due to the direction and magnitude of air flow. Thus, there is a need to be able to measure the loads associated with blades in an efficient, cost-effective manner.

### SUMMARY

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Aspects described herein provide a system, apparatus, method and/or computer readable medium for determining a force (e.g., a load, moment, distribution of load, etc.) based on a pressure differential between two pressure sensing locations. This determination may be performed in a variety of ways including using a neural network, regression models and the like. Based on the determination, other parameters may be determined or controlled, including, but not limited to, yaw, pitch, deflector actuation, and the like. Additionally or alternatively, the magnitude and/or pattern of forces related to the blade or turbine may be used to determine fatigue and/or faults. Accordingly, controls may be implemented in response to and to compensate for the determined fatigue or fault.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates a perspective view of a wind turbine according to one or more aspects of the disclosure.

FIG. 2 illustrates a cross-section of a blade comprising a pressure based load measurement system according to one or more aspects of the disclosure.

FIG. 3A illustrates a graph depicting a normal force coefficient versus a pressure differential coefficient according to one or more aspects of the disclosure.

FIG. 3B illustrates a graph depicting a tangential force coefficient versus a pressure differential coefficient according to one or more aspects of the disclosure.

FIG. 4 illustrates exemplary forces acting on an aerodynamic load bearing member according to one or more aspects of the disclosure.

FIG. 5 illustrates a graph depicting the relationship between normalized pressure differential measurements and blade root bending moments according to one or more aspects of the disclosure.

FIG. 6 illustrates an example system of an artificial neural network in accordance with one or more features disclosed herein according to one or more aspects of the disclosure.

FIG. 7 illustrates an example system of an artificial neural network in accordance with one or more features disclosed herein according to one or more aspects of the disclosure.

FIG. 8 illustrates an example single-layer artificial neural network with a plurality of inputs according to one or more aspects of the disclosure.

FIG. 9 illustrates an example multi-layer feed-forward artificial neural network with a plurality of inputs according to one or more aspects of the disclosure.

FIG. 10 illustrates an example process of configuring, training, and implementing an artificial neural network according to one or more aspects of the disclosure.

FIG. 11 illustrates an example two-layer artificial neural network according to one or more aspects of the disclosure.

FIG. 12 illustrates an example graph depicting a time-series response for an artificial neural network according to one or more aspects of the disclosure.

FIGS. 13A-13D illustrate example graphs depicting bending moment values and force quantities according to one or more aspects of the disclosure.

FIGS. 14A-14D illustrate example graphs depicting bending moment values and force quantities at the low-speed shaft bearing location according to one or more aspects of the disclosure.

FIG. 15 illustrates an example graph depicting correlation coefficient values determined for a measured and estimated normal force according to one or more aspects of the disclosure.

FIG. 16 illustrates an example process for optimizing and/or balancing blades of a wind turbine according to one or more aspects of the disclosure.

### DETAILED DESCRIPTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

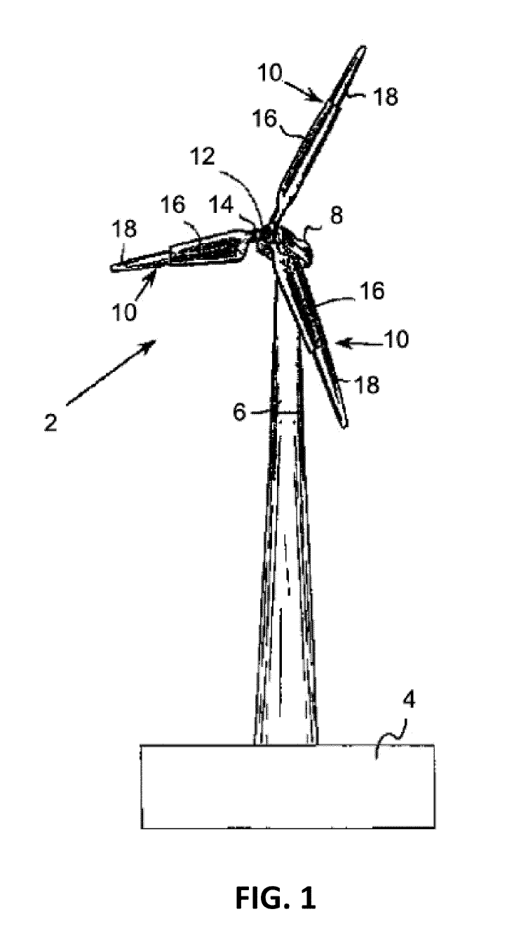

FIG. 1 illustrates a wind turbine 2 on a foundation 4 with a tower 6 supporting a nacelle 8. One or more blades 10 are attached to a hub 12 via a bolt flange 14. The hub 12 is connected to a drive train (not shown) within the nacelle 8. The blades 10 may have a root portion 16 and a tip portion 18. In one arrangement, blades 10 may be fixed length rotor blades having root portion 16 and tip portion 18. In another arrangement, the blades 10 may be variable length blades, which may be configured to extend and/or retract given certain conditions. Various modes for controlling a variable length blade may be used to optimize or otherwise increase the effectiveness of such blades and/or a turbine such as wind turbine 2 to which the blades are attached. Any desirable drive system, such as a screw drive, a piston/cylinder, or a pulley/winch arrangement may be used to move the tip portion 18 with respect to the root portion 16. Such drive systems are described in U.S. Pat. No. 6,902,370, titled “Telescoping Wind Turbine,” and filed Jun. 4, 2002, which is hereby incorporated by reference. The wind turbine 2 further includes a yaw drive and a yaw motor, and may include a pitch control system, not shown. Alternatively or additionally, blades 10 may include a mix of variable length and fixed length rotor blades.

According to yet other aspects, blades 10 may include one or more deployable air deflectors configured to modify airflow by extending from a surface of blades 10. In other embodiments, additional features (not shown) and/or methods may be used to modify airflow along a blade. For example, blade pitch may be modified, one or more plasma actuators may be actuated, a wind turbine may utilize active suction/blowing, one or more flaps disposed on a blade may be activated, etc., in order to modify the airflow. Modification of the airflow may result in the increase of lift and/or decrease in load. A controller may thus modify the power output, efficiency, load and the like using the deployable air deflectors. Examples of deployable air deflectors are described in U.S. patent application Ser. No. 12/122,584, titled “Wind Turbine with Gust Compensation Air Deflector,” and filed May 16, 2008, which is hereby incorporated by reference.

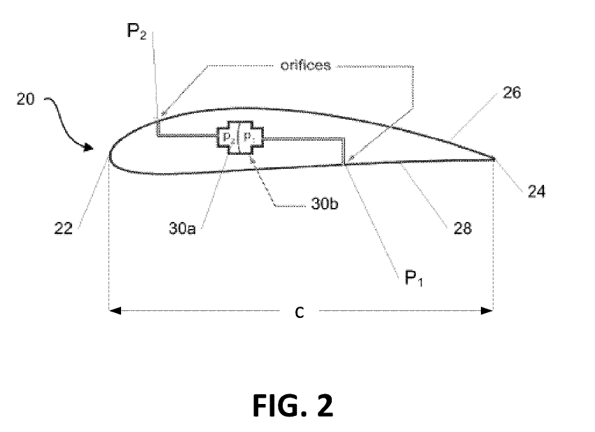

FIG. 2 illustrates one example cross section of an airfoil, such as from an airplane wing, wind turbine blade, etc. as used in conjunction with the present disclosure. The airfoil includes a leading edge 22, a trailing edge 24, a top surface 26, and a bottom surface 28. A chord line, c, can be defined as a line between the leading edge 22 and the trailing edge 24 of the airfoil 20. The airfoil 20 shown in FIG. 2 is merely one illustrative cross-sectional design and it is recognized that infinite cross-sectional variations can be used as part of the present invention. The airfoil 20 may be made of any suitable construction and materials, such as fiberglass and/or carbon fiber.

With further reference to FIG. 2, the blade 20 includes orifices at two pressure sensing locations, P1 and P2. P1 is located on the bottom surface 28 of the blade 20 and P2 is located on the top surface 26 of the blade 20. A pressure transducer, 30, is provided to measure pressure differential between the two pressure sensing locations. Locations 30a, 30b indicate opposing sides of the pressure transducer diaphragm to determine the pressure differential between each point P1 and P2. In an alternate arrangement, multiple pressure transducers may be used. The location of P1 and P2 shown in FIG. 2 is merely illustrative of one example location of each orifice. The location of P1 and P2 may be generally dependent on the blade 20 or wing cross-sectional geometry. In one example, the location of the pressure sensors and ports may correspond to 0.125 c and 0.150 c on the pressure and suction surfaces, respectively, where c represents the chord length. This range may, in some examples, be preferable to reduce the error to within a specified threshold (e.g., 7%). In some embodiments, P1 and P2 may be disposed, e.g., between 5% and 70% of the length of chord c, and, in some embodiments, disposed, e.g., between 10% and 60% of the length of chord c.

Using the pressure differential between P₁ and P₂, a controller may determine various loads of a blade including a lifting load, a normal force load, a tangent force load, an in-plane (power producing) load, and a rotor normal load. More specifically, the aerodynamic forces and moments generated along the span of a blade are proportional to a difference in pressure between two points on an airfoil surface. Using a determined local dynamic pressure and the measured pressure differential (i.e., the difference in pressures between P₁ and P₂), the loads acting upon a blade can be readily determined. Generally, the local dynamic pressure (or estimated value thereof) may be determined using the following equation:

qₑₛₜ≡½ρ_{∞}νₑₛₜ² (1)

where ρ_{∞} corresponds to the ambient air density and νₑₛₜ corresponds to the estimated local air speed at the pressure sensors. For a wind turbine, an estimate of the wind air speed can be obtained using the rotor speed and wind speed, as defined in equation 2:

νₑₛₜ≡\sqrt{ωᵣₒₜₒᵣ²rₛₑₙₛₒᵣ²+ν_{wind,est}²} (2)

That is, an estimated value of local air speed in the vicinity of the pressure sensors (νₑₛₜ) may be calculated using the known rotor speed (ωᵣₒₜₒᵣ), the radial position of the pressure sensors (rₛₑₙₛₒᵣ), and the wind speed (ν_{wind,est}). In some instances, the wind speed might not be directly measurable (e.g., sensors might not be used or included in the blade or turbine to measure the wind speed). In such instances, the wind speed may be determined empirically using the wind turbine as an anemometer. The following set of equations estimate wind speed based upon the rotor speed depending on the pitch angle of the blade (β):

$${v}_{wind , est} \approx \{ \begin{matrix}{κ}_{ω 1} {ω}_{rotor} + {κ}_{ω0} & for β = {β}_{min} ( Region II ) \\ {κ}_{p 2} {β}^{2} + {κ}_{p 1} β + {κ}_{p 0} & for β > {β}_{min} ( Region III )\end{matrix} \qquad ( 3 )$$

where κ_{ω#} and κ_{p#} represent empirically determined coefficients and β represents the blade pitch having a minimum of βₘᵢₙ. The different regions may have different load profiles and thus require different algorithms or formulas for determining the estimated load given the various data inputs. As one particular example in which simulations were performed for a 750 kW ZOND™ turbine with a 48 m rotor comprised of three EUROS™ blades, the following Region II and Region III coefficients were determined:

Region II

κ_{w1} = 2.913 m/rad
κ_{w0} = −0.094 m/s

Region III

κₚ₂ = 68.739 m/(s · rad²)
κₚ₁ = 14.307 m/(s · rad)
κₚ₀ = 10.331 m/s

Once the local dynamic pressure has been calculated, it is used to nondimensionalize the measured pressure differential, resulting in a pressure differential coefficient (C_{ΔP}) as detailed in equation 4:

$${C}_{Δ p} ≡ \frac{Δ p}{{q}_{est}} \qquad ( 4 )$$

This pressure differential coefficient, along with empirically determined constants, can be used to estimate each load associated with the blade. Specifically, in one embodiment, in order to calculate any of the above-noted loads (e.g., lifting load, normal force load, tangent force load, in-plane load) based on the measured pressure differential, a coefficient for each force corresponding to each load may be calculated using the determined pressure differential coefficient. Equations 5, 6, and 7 are example formulas for calculating the lift force coefficient (C_{l,est}), normal force coefficient (C_{n,est}), and tangent force coefficient (C_{t,est}), respectively. In some arrangements, these coefficients may represent estimated coefficients or values rather than actual.

C_{l,est}≡κₗ₁C_{Δp}+κₗ₀ (5)

C_{n,est}≡κₙ₁C_{Δp}+κₙ₀ (6)

C_{t,est}≡κₜ₂C_{Δp}+κₜ₁C_{Δp}+κₜ₀ (7)

In equations 5, 6, and 7, κ_{l#}, κ_{n#} and κ_{t#} each represent empirical coefficients that may depend upon local blade section geometry and pressure orifice installation locations. As shown by equations 5, 6, and 7, the pressure differential coefficient has a linear relationship with each of the lift force coefficient and the normal force coefficient, and has a quadratic relationship with the tangent force coefficient. To determine each of the empirical coefficients, the linear or quadratic relationship may be fitted to empirical or calculated data collected for the type of blade (e.g., blade section geometry) and/or pressure sensor installation locations.

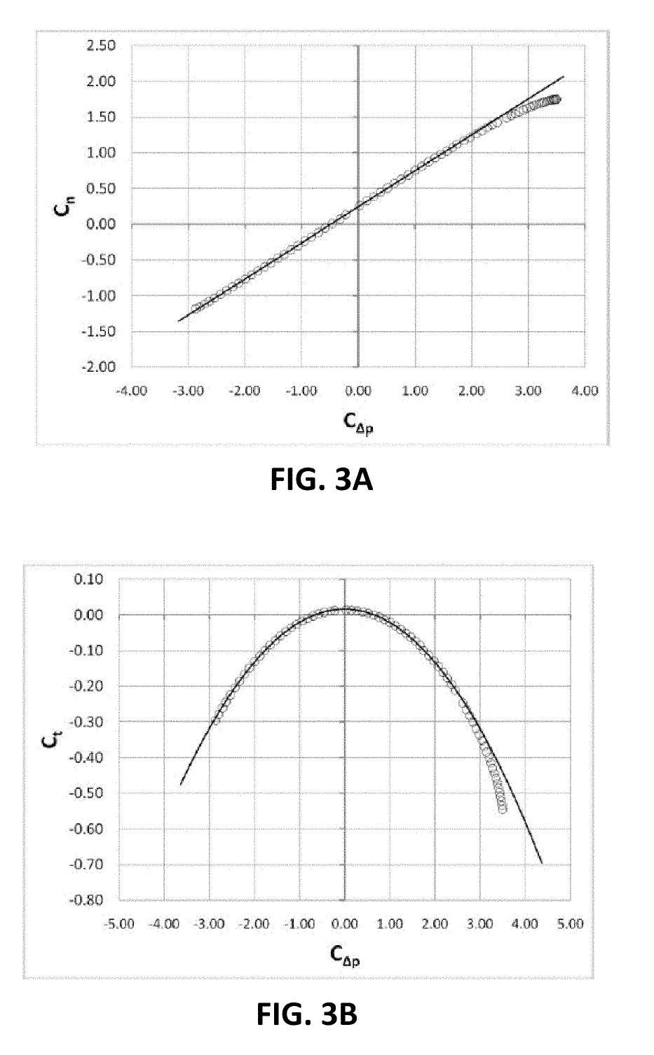

FIG. 3A illustrates an example linear fit between the pressure differential coefficient (C_{Δp}) and the normal force coefficient (Cₙ) based on empirical data for a particular type of blade and sensor installation location. For example, simulations and/or tests may be performed on a blade of the particular type and having the pressure sensors located at the sensor installation locations. The results of the tests and/or simulation may then be analyzed to identify a linear relationship between C_{Δp} and Cₙ. In some arrangements, best-fit algorithms (e.g., least squares) may be used to compute the relationship between the pressure differential coefficient and each of the other coefficients.

Similarly, FIG. 3B illustrates an example quadratic relationship between the pressure differential coefficient (C_{Δp}) and the tangential force coefficient (Cₜ). Again, data collected through empirical studies and analyses may be used to derive the quadratic relationship for a particular type of blade and/or pressure sensor installation location.

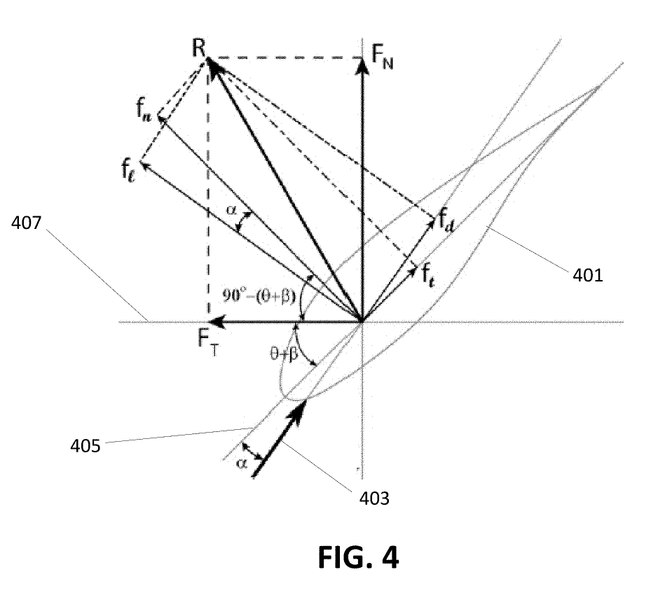

FIG. 4 is a diagram illustrating example forces acting upon a rotor blade 401 along with an example wind vector 403. The illustrated forces may be computed using a Multiblade Coordinate (MBC) transformation, and may include the resultant force (R), lift force (fₗ), drag force (f_{d}), normal force (fₙ), tangent force (fₜ), rotor-normal force (F_{N}), and rotor-tangent force (F_{T}). For example, the rotor-normal force F_{N} is perpendicular to the rotor plane 407 while the normal force fₙ is normal to the chord line 405 of the rotor blade 401. The forces normal to the rotor plane 407 may be used to determine root bending moments, which contributes to stress on the blade. Accordingly, controls may be implemented to minimize the root bending moments or to optimize power output. In one example, optimizing power output may include balancing the root bending moment while maximizing in-plane power-producing loads. Modification of bending moments, normal loads, low-speed shaft moments, low-speed shaft loads, power-producing loads, and other forces, loads, and moments may be controlled in a variety of ways including changing blade pitch or yaw, deploying air deflectors, extending/retracting expandable and retractable blades, and the like, as is described in further detail below.

Using the estimated lift force, normal force, and tangent force coefficients (as determined by, e.g., equations 5, 6, and 7 respectively), and the estimated local dynamic pressure (as determined by, e.g., equation 1), the lifting load ( [symbol] ), normal force load (η), and tangent force load (τ) may be estimated based on the following equations:

[symbol]

≡qₑₛₜC_{l,est} (8)

η≡qₑₛₜC_{n,est} (9)

τ≡qₑₛₜC_{t,est} (10)

Equations 8, 9, and 10 estimate aerodynamic loads in the local chord-fixed reference frame. In general, these loads can be translated into other reference frames if the appropriate transformation angles are known. For example, the load normal to the rotor plane may be calculated using the determined normal and tangent force loads of the local chord-fixed reference frame based on the following equation:

L_{N}≡η cos(θₛₑₙₛₒᵣ+β)+τ sin(θₛₑₙₛₒᵣ+β) (11)

where θₛₑₙₛₒᵣ corresponds to the blade twist angle at the sensor location and β corresponds to the blade pitch angle (as discussed). Generally, the top and bottom sensors will be located in corresponding radial positions on a top surface and a bottom surface of the blade. Accordingly, the blade twist angle will be the same. To calculate the normal load in the blade-fixed reference frame, β is set to zero.

Similarly, the tangential loads relative to various reference frames may be calculated based on the determined normal and tangent force loads (relative to the local chord-fixed reference frame). For example, the following tangential load equation may be applied:

L_{T}≡η sin(θₛₑₙₛₒᵣ+β)−τ cos(θₛₑₙₛₒᵣ+β) (12)

Again, the tangential load in the blade-fixed reference frame may be calculated by setting the blade pitch angle β to zero.

Various embodiments may use measured/determined pressure differentials/measurements (e.g., Δp) to determine load information at different turbine locations. In some situations, strain gauges (e.g., conventional resistive gauges) may be installed at various locations of interest on a turbine, such as at the blade root, low-speed shaft, tower top, etc. These strain gauges may then be used to measure turbine loads. However, in some cases, these strain gauges may be too expensive, need frequent recalibration, and/or otherwise be not as reliable or accurate as needed to determine accurate load information.

Sensors, such as ones located on an airfoil and used to measure pressure differentials, may provide a real-time capture of the aerodynamics of the rotor, and thus may provide more information regarding the turbine's behavior. According to some aspects, estimating/determining loads and moments directly from the pressure differentials/measurements may allow for the elimination of the use of strain gauges. The estimated/determined load and moment information may be used in the design of a turbine controller, which may then be used to improve the turbine performance. For example, if an estimated load or moment is determined to be greater than a threshold (or other desired amount), the estimated load or moment information may be transmitted as a feedback signal into a turbine controller. The turbine controller may then modify one or more characteristics of the wind turbine to decrease the load or moment in response to receiving the feedback signal.

Pressure differential measurements, such as discussed above, may be used to determine loads and moments, such as a bending moment measured at the root portion of a blade (e.g., root 16 in FIG. 1) or bending moment measured at the low-speed shaft. According to some aspects, a correlation coefficient may show a correlation or relationship between the pressure differential measurements and root bending moment. Various models may be determined for estimating moments using pressure differential measurements. For example, an artificial neural network may be developed to estimate the root bending moment. Features described below illustrate example embodiments of determining moments using, for example, pressure differential measurements and associated values.

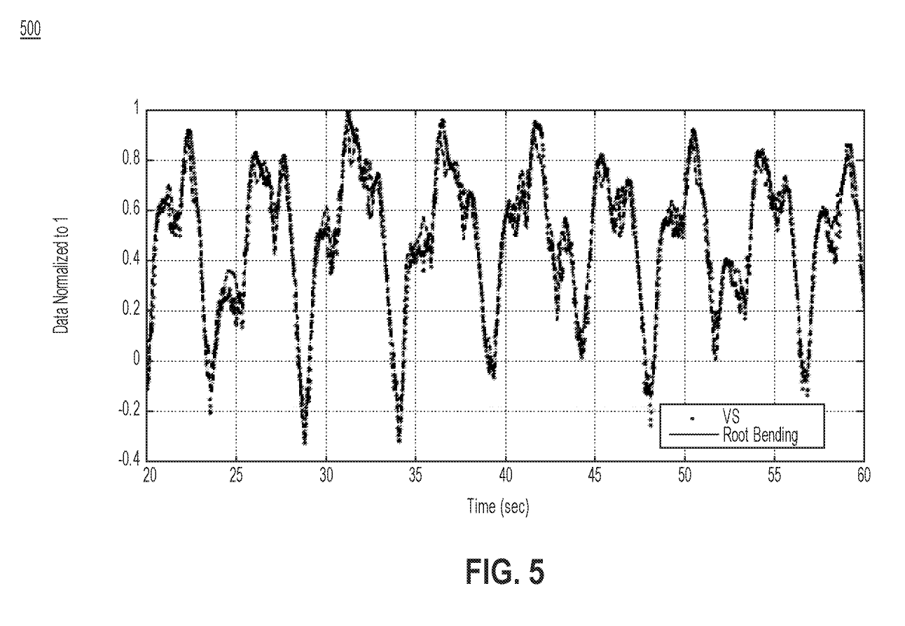

In some examples, a correlation may be determined between the pressure differential measurements and measured root-bending moments. FIG. 5 illustrates an example graph 500 showing the relationship between the measured (or estimated) pressure differential measurements on an airfoil (VS) and the measured (or estimated) root bending moment of the blade. This graph may be based on empirical data for a particular type of blade and sensor installation location. For example, simulations and/or tests may be performed on a blade of the particular type and having the pressure sensors located at the sensor installation locations. In a particular arrangement, graph 500 may represent normalized pressure differential measurements and root bending moments for a 2-minute segment of test data with a mean wind speed of 16 m/s. The results of the tests and/or simulation may then be analyzed to identify a correlation between the pressure differential values and the root bending moments. The correlation between the pressure differential values and the root bending moments may be determined according to the following equation:

$${ρ}_{X , Y} = \frac{cov ( X , Y )}{{σ}_{X} {σ}_{Y}} \qquad ( 13 )$$

where ρ_{X,Y} represents the correlation coefficient between X and Y, cov(X, Y) represents the covariance between X and Y, and σ_{X} represents the standard deviation of X, and σ_{Y} represents the standard deviation of Y. The correlation coefficient may represent the degree of linear dependence between two variables, such as the pressure differential (X) and the root bending moment (Y). The value of ρ_{X,Y} may range between −1 and 1, with 1 (or −1) indicating a total positive (or negative) correlation, and 0 representing no correlation.

Accordingly, using the values of the two plots in graph 500 in the correlation coefficient equation, a high correlation (e.g., close to −1 or 1) may be determined between the pressure differential measurements and the root bending moments for each sample. For example, the correlation coefficient between the pressure differential values and the root bending moments shown in the graph 500 illustrated in FIG. 5 may be calculated to be 0.95. This high degree of correlation is illustrated in graph 500 by the close overlay of the two plots in graph 500.

Because of this strong correlation between the pressure differential signals and the measured root bending moment signals, a root bending moment may be estimated/determined from a pressure differential measurement value in accordance with one or more of the aspects disclosed herein, such as a neural network model or a regression model. While FIG. 5 shows the correlation for one blade on a turbine, the correlation may also be performed for any other blade on the turbine.

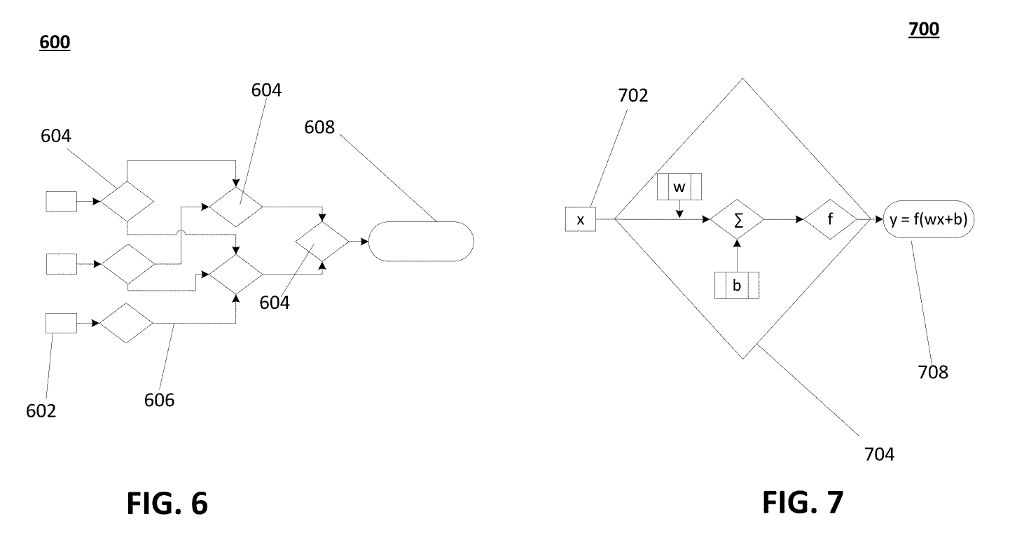

In one illustration, moments (e.g., the root bending moment) may be estimated/determined via an artificial neural network model. For example, the artificial neural network may be developed using the pressure differential measurements as inputs to the artificial neural network and may produce an estimated root bending moment as an output. FIG. 6 illustrates an example system 600 of an artificial neural network in accordance with one or more features disclosed herein. System 600 may include one or more inputs 602, which may connect to one or more neurons 604 via one or more synapses 606. These neurons may then cooperate to perform a desired function, which may then produce one or more outputs 608.

According to some aspects, the artificial neural network system 600 may behave like a function approximator by transforming inputs into outputs.

In some arrangements, neural networks may be used to model complex and/or unknown relationships between inputs and outputs. For example, an artificial neural network may be used to model the relationship between one or more pressure differential measurements and one or more root bending moments. Thus, using the pressure differential measurements as inputs, an artificial neural network system of one or more neurons 604 and synapses 606 may be determined for estimating a root bending moment at a particular time. The artificial neural network system may be trained/refined based on previously measured pressure differential measurements input into the model. After the training is complete, the artificial neural network system may then be used to determine root bending moments for using a subsequent pressure differential measurement value as an input.

FIG. 7 illustrates an example artificial neural network system 700 including an input 702, a single neuron 704, and an output 708 in an artificial neural network (ANN). The ANN 700 may illustrate the relationship between pressure differential measurements and estimated moment values. The output 708 (e.g., an estimated moment value) may be a function (f) of the weighted sum (w) of the input signal (x) plus a bias (b). Both w and b may be adjustable. For example, the neuron 704's learning process may include updating w and b according to a given input x and output y (e.g., in supervised learning, which is described in further detail below). The function f may be called a transfer function or activation function. According to some aspects, the function f may model the relationship between pressure differential measurements (inputs) and estimated moment values (outputs). According to some embodiments, f may be a sigmoid function, which is continuous, smooth, and monotonically increasing. In other embodiments, f may be a linear function or some other function.

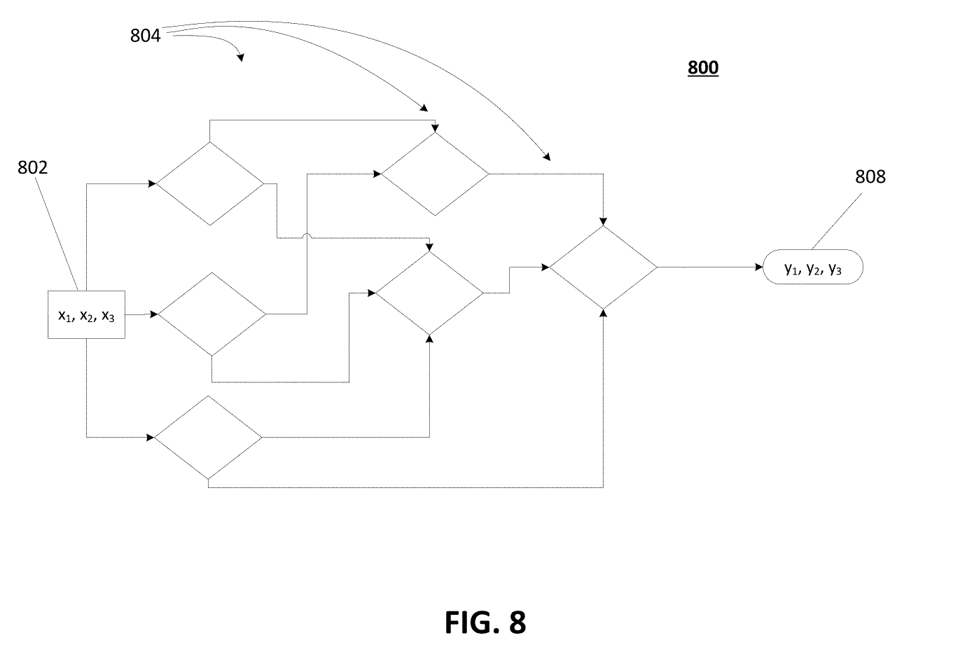

Artificial neural networks may be composed of one or more layers of neurons. The more layers an ANN comprises, the more complicated the relationship between the input and output of the ANN may be. FIG. 8 illustrates an example single-layer ANN 800 with inputs 802, one or more layers of neurons 804, and outputs 808. For example, a first set of pressure differential data may be the input and may be used to create the ANN 800. This first set of pressure differential data (x₁, x₂, x₃) may have been previously measured (as described herein). A first output of a root bending moment (y₁, y₂, y₃) may be produced by the ANN 800 based on the first set of pressure differential data. Inputs 802 may comprise a vector input, such that information may flow in one direction (e.g., from input to output). According to some embodiments, one or more of the output signals 808 may be fed back to the input 802 (e.g., in a recurrent network). In the above example, for a vector input system, the first set of pressure differential data may be fed into the ANN 800, the ANN 800 may be trained using that data, a first root bending moment may be produced as an output, and then a second set of pressure differential data may be input into the ANN 800 to further refine/train the ANN 800 or to determine a corresponding root bending moment. In a feedback system, the first root bending moment may be fed back into the system, such as being fed back as an input.

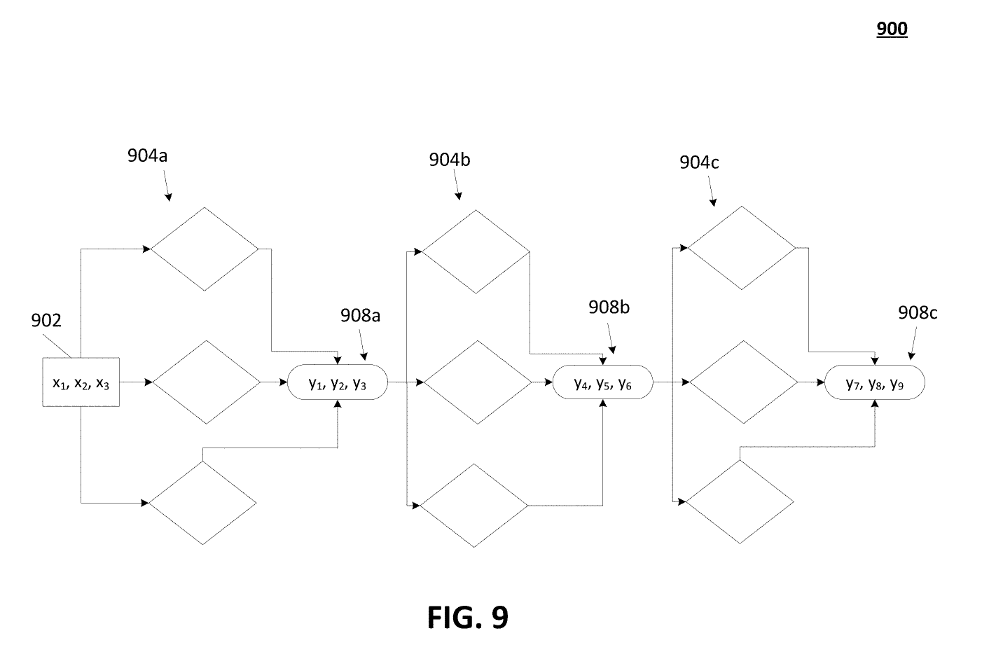

FIG. 9 illustrates an example multi-layer ANN 900 with inputs 902, a first layer of neurons 904a, which produces outputs 908a. Outputs 908a may then feed into a second layer of neurons 904b, which produces outputs 908b that feed into a third layer of neurons 904c, which then produce outputs 908c. According to some aspects, ANN 900 may be a feed-forward system. According to some embodiments, inputs 902 may comprise a vector input. According to some aspects, one or more of the output signals 908a-c may be fed back to the input 902.

According to some aspects, an ANN may “learn” by optimizing a cost function. In some embodiments, there may be three types of learning paradigms: supervised, unsupervised, and reinforcement learning. In supervised learning, the ANN may be provided with training data, such as previous measurements or observations and/or historical mapping from input to output. In supervised learning, the ANN may be used to find the mapping from the input to the desired/target output (e.g., data inference). The cost function for supervised learning may be related to the mismatch or difference between output produced by the ANN and the target output. An example of a cost function for supervised learning may be the mean-squared error between the output produced by the ANN and the target output. For example, the mean-squared error may be calculated between root bending moment values/signals determined by the ANN and target root bending moment values/signals.

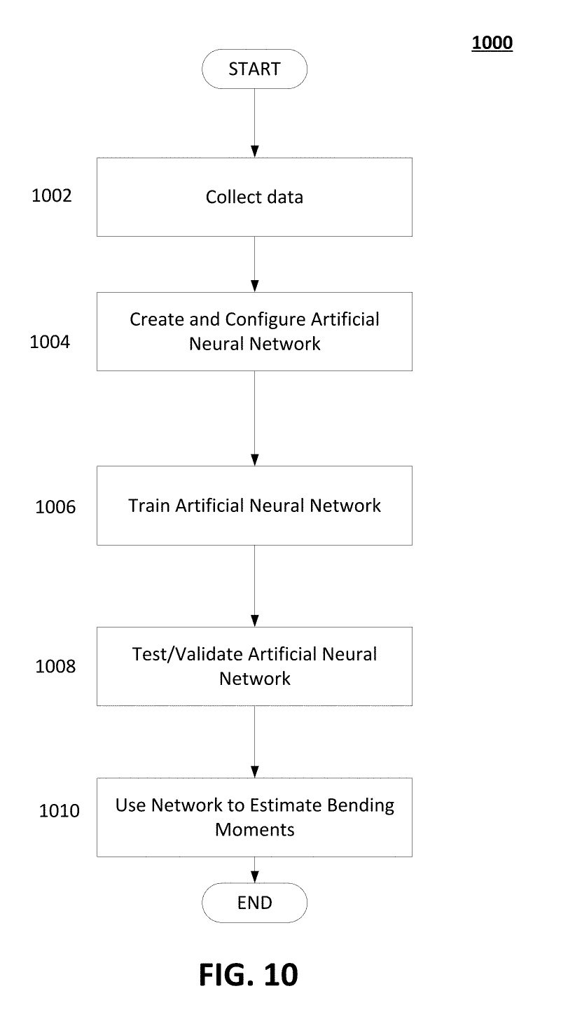

In unsupervised learning, the ANN might not be provided with training data, and the ANN may be used to find hidden structure in unlabeled data. For unlabeled data, there might not be a target output, because there might be no prior knowledge of what the target/desired output should be. Thus, according to some aspects, unsupervised learning may use clustering to find an accurate output and/or ANN model. For example, an ANN may be developed with a set of inputs (e.g., pressure differential measurements) that produce an output (e.g., bending moments). The output may vary each time the same set of inputs is input into the system. For example, the output values for the root-bending moment may range from 14 kN·m to 20 kN·m. However, without knowing what a desired value for the bending moment may be for the set of pressure values input into the ANN, there may be no way of knowing if the model is providing an accurate estimate of the root-bending moment. Thus, using a clustering technique, it may be determined what values the outputs cluster around. For example, if many of the outputs cluster around 15 kN·m, then 15 kN·m may provide the most accurate or best output for that ANN. In reinforcement learning, the ANN may be used to find out how an agent takes actions in an environment to maximize a reward. For example, after a set of pressure differential measurements are input into an ANN, and a first output of a bending moment may be produced. Then, after the set of pressure differential measurements are input into the ANN a subsequent time, the ANN may make modifications to how the inputs are used in the ANN to minimize a cost function (e.g., the difference between the target output and the estimated output). Reinforcement learning may focus on the on-line performance, and may use control theory, information theory, and/or statistics. While general neural network concepts may be shown in FIGS. 6-9, one or more approaches of implementing a neural network is illustrated in FIGS. 10-12 and discussed herein.

FIG. 10 illustrates a process 1000 of an example method for collecting data, creating and configuring an ANN (e.g., as described above), training the ANN, validating the ANN, and implementing the ANN to determine/estimate bending moments of a blade in accordance with one or more features disclosed herein. In one or more embodiments, the process illustrated in FIG. 10 and/or one or more steps thereof may be performed by a computing device (e.g., a control device such as a turbine control device and the like). In other embodiments, the process illustrated in FIG. 10 and/or one or more steps thereof may be embodied in computer-executable instructions that are stored in a computer-readable medium, such as a non-transitory computer-readable memory. Any of the disclosed steps in FIG. 10 may be omitted, be performed in other than the recited order, repeated, and/or combined.

In step 1002, a computing system may collect, receive, or otherwise determine data and information (e.g., pressure measurements, pressure differentials, etc.) that may be used in training and validating an ANN. For example, data may be collected over a range of wind speed from 4 m/s to 20 m/s for various types of wind turbines. The computing system may comprise a controller for modifying or otherwise setting characteristics of a wind turbine, an airfoil, devices in or on an airfoil, sets of wind turbines and the like and/or combinations thereof. The computing system may correspond to a controller for an air deflector device in one or more examples. Alternatively or additionally, the computing system may correspond to a controller for an entire blade. In yet other examples, the computing system may be configured to control all or a subset of devices within a wind turbine. In still another example, the computing system may be configured to control multiple wind turbines.

At step 1004, a computing system may create and/or configure an ANN based on the collected data. For example, the computing system may determine the ANN's structure, the number of inputs, the number of layers of neurons, the number of neurons per layer, and the like.

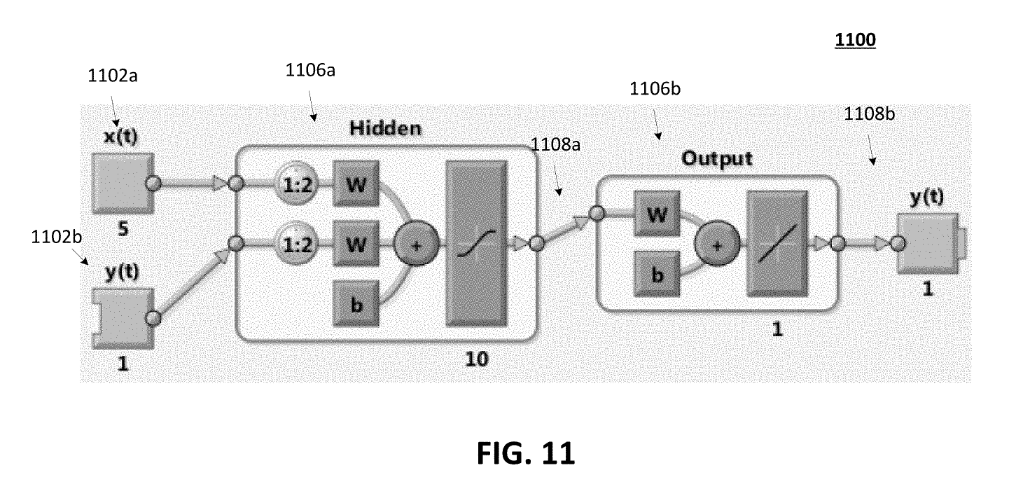

FIG. 11 illustrates a two-layer ANN 1100. According to some embodiments, an ANN may be created for any combination of blades of a turbine. According to some aspects, the ANN 1100 may represent one blade of a turbine. However, an ANN may represent two blades, three blades, or more than three blades if available. ANN 1100 may include a first input 1102a, x(t), which may represent one or more previously determined/measured pressure differential measurements. For example, the number of inputs 1102a may correspond to the number of sensors on the blade. As shown in FIG. 11, there may be 5 pressure differential measurements (e.g., one from each sensor) used in ANN 1100, as denoted by the “5” below the x(t) input box.

ANN 1100 may include a second input 1102b, y(t), which may represent one or more previously determined/measured bending moments (e.g., flap-wise root bending moments). According to some aspects, a non-linear auto-regression model with external inputs (NARX) may be used to incorporate the information from the past into the ANN. Accordingly, the bending moment input into the ANN may be represented by the following equation:

y(t)=f(y(t−1), . . . ,y(t−d),x(t−1), . . . ,x(t−p)) (14)

where t represents time, y represents one or more bending moments on a blade, x represents one or more pressure differential measurements, and d and p represent time offsets (e.g., delays). In some embodiments, d and/or p may be any integer greater than 1. For example, if 4 measurements were taken of the bending moment, then d may equal 4, and if 6 measurements were taken at a particular pressure sensor of the pressure differential, then p may equal 6. According to some embodiments, such as shown in FIG. 11, d and p may be selected as d=2 and p=2. Higher order terms (e.g., d and p equaling greater than 2) may improve the estimation accuracy of the ANN. As shown in FIG. 11, there may be one bending moment location used as an input in ANN 1100, as denoted by the “1” below the y(t) input box.

ANN 1100 may include a first neuron layer 1106a, which may be a hidden layer (e.g., its output might not be directly observed or otherwise seen, but may be input into another layer). Layer 1106a may include one or more neurons. Layer 1106a may include a 2-step delay (e.g., shown in FIG. 11 as 1:2). A delay may correspond to how many measurements were taken over time. As discussed above, d and p may be selected as d=2 and p=2, and accordingly there may be a 2-step delay. Therefore, pressure differential measurements and bending moment measurements corresponding to this 2-step delay may be input into layer 1106a. As discussed above, each input may be acted upon with a weighted sum (w) and a bias (b). In ANN 1100, layer 1106a may include 10 neurons, which may correspond to a sigmoid function as denoted by the “10” under the image of the sigmoid function. According to some aspects, any number of neurons and any function may be used. The output 1108a from the first layer 1106a may then be input into a second neuron layer 1106b. The second layer 1106b may be an output layer (e.g., its output may be directly observed or otherwise seen). This input (the output 1108a) may then be acted upon by a weighted sum (w) and a bias (b). In ANN 1100, layer 1106b may include 1 neuron, which may correspond to a linear function as denoted by the “1” under the image of the linear function. According to some aspects, any number of neurons and any function may be used. Layer 1106b may then produce an output 1108b. Output 1108b may be the desired data/measurement for the ANN. For example, output 1108b may be a function used to determine the flap-wise root bending moments at a particular time or for a particular input.

Referring to FIG. 10, at step 1006, the ANN 1100 may be trained by a computing device. In some embodiments, a minimization algorithm may be used to train the ANN 1100. For example, the Levenberg-Marquardt algorithm may be used to train ANN 1100, and a mean-squared error (MSE) may be used as the performance measure. MSE may be defined as:

$$MSE = \frac{1}{N} \sqrt{{\sum }_{i = 1}^{N} {( {y}_{i} - {y}_{i}^{*} )}^{2}} \qquad ( 15 )$$

where y represents the target signal (e.g., bending moment) that is to be determined/estimated, and y* represents the output 1108b from ANN 1100. Thus, the ANN 1100 (and any portion thereof, such as the neurons, functions, delays, etc.) may be configured/reconfigured to minimize the MSE.

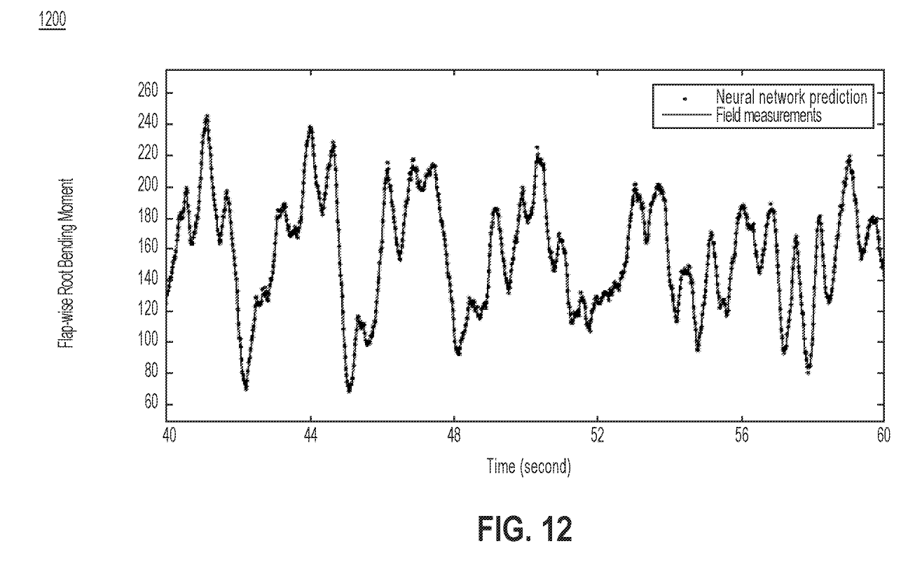

At step 1008, the ANN 1100 may be tested and/or validated. For example, a time-series response of the ANN may be determined. FIG. 12 shows a graph 1200 of a time-series response of the ANN. The vertical axis represents the flap-wise root bending moment (in kN·m), which may be estimated from, for example, a stain gauge voltage. The graph 1200 illustrates the output bending moment (1108b) from ANN 1100 (shown as “*”) and the target or field measured bending moment (shown as “−”), which may be measured using strain gauges. As shown in FIG. 12, the output 1108b from ANN 1100 very closely corresponds to the target signal. According to some aspects, a mean-squared error value (e.g., target—ANN output) of 16 kN·m for a neural-network-determined root bending moment value of about 900 kN·m may demonstrate very good performance of the ANN 1100. According to some aspects, larger errors may occur at times corresponding to each 2-minute segment, and may last for 2 time steps (equal to 0.04 seconds). After these 2 time steps, the ANN may adapt to these changes, thereby reducing the error to within, for example, 5 kN·m for subsequent time steps.

Referring again to FIG. 10, at step 1010, a turbine control system or other computing device may implement the ANN 1000 to estimate bending moments for any of the blades of the turbine. For example, the turbine control system may appropriately modify blade and turbine characteristics in response to compensate for or otherwise address various bending moment and bending moment conditions. In one example, a turbine control system may modify blade or turbine characteristics such as deployment/retraction of air deflectors on a blade, extension/retraction of a tip portion of a blade, modifying pitch and/or yaw angles, and the like. Process 1000 may then end at step 1012.

According to some embodiments, a computing device may determine that the tangential aerodynamic forces on the blade elements may be correlated to the tilt and yaw bending moments of the low-speed shaft. According to some aspects, these moments may be in the rotating plane or in the stationary plane of the blade, at the locations of the shaft tip, flange, or bearing. With respect to FIG. 3B, the tangential force (F_{T}) may be related to the pressure differential (Δp) through a second-order polynomial equation:

F_{T}=k₂Δp²+k₁Δp+k₀ (16)

Where k₂, k₁, and k₀ are constants. Various force quantities may be calculated based on equation 16. For example, four force quantities may be calculated from F_{T} using the Multiblade Coordinate (MBC) transformation, as discussed with respect to FIG. 4:

F_{T}^{zs}=F_{T}_{₁}*cos(θ)+F_{T}_{₂}*cos(θ+2π/3)+F_{T}_{₃}*cos(θ+4π/3) (17)

F_{T}^{ys}=F_{T}_{₁}*sin(θ)+F_{T}_{₂}*sin(θ+2π/3)+F_{T}_{₃}*sin(θ+4π/3) (18)

F_{T}^{za}=F_{T}_{₁}*cos(0)+F_{T}_{₂}*cos(2π/3)+F_{T}_{₃}*cos(4π/3) (19)

F_{T}^{ya}=F_{T}_{₁}*sin(0)+F_{T}_{₂}*sin(2π/3)+F_{T}_{₃}*sin(4π/3) (20)

where θ represents the azimuthal angle (in radians) of a blade. In some arrangements, F_{T}_{₁}, F_{T}_{₂}, and F_{T}_{₃} may be determined empirically and/or using simulations.

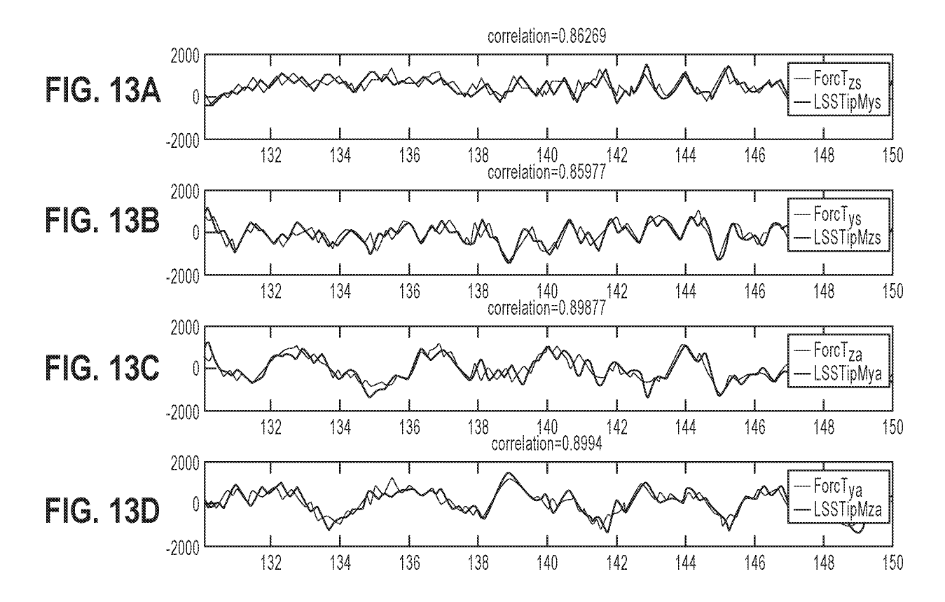

FIGS. 13A-13D illustrate example graphs showing the signals/values of the various measured (or estimated) bending moments and four force quantities at the low-speed shaft tip location. For example, the forces are illustrated as follows:
M_{TIP}^{ys}: Stationary low-speed shaft tip bending moment—pitch
M_{TIP}^{zs}: Stationary low-speed shaft tip bending moment—yaw
M_{TIP}^{ya}: Rotating low-speed shaft tip bending moment—pitch
M_{TIP}^{za}: Rotating low-speed shaft tip bending moment—yaw

As can be seen, the two signals trace each other very closely, which may indicate a high correlation.

Taking into consideration the gravity of the hub and each blade, three additional quantities may be calculated to account for the correlation between F_{T} and the low-speed shaft loads at the bearing (or flange) location.

with g representing the gravitational acceleration, D representing the distance between the low-speed shaft tip and the bearing, and k₁, k₂ and k₃ are constants. It is noted that for low-speed shaft flange loads, the correlation pairs may be similar and/or the same as the correlation pairs for the low-speed shaft bearing loads. A modification for the correlation pairs for the low-speed shaft flange loads may include the value of D representing the distance between the low-speed shaft tip and the flange.

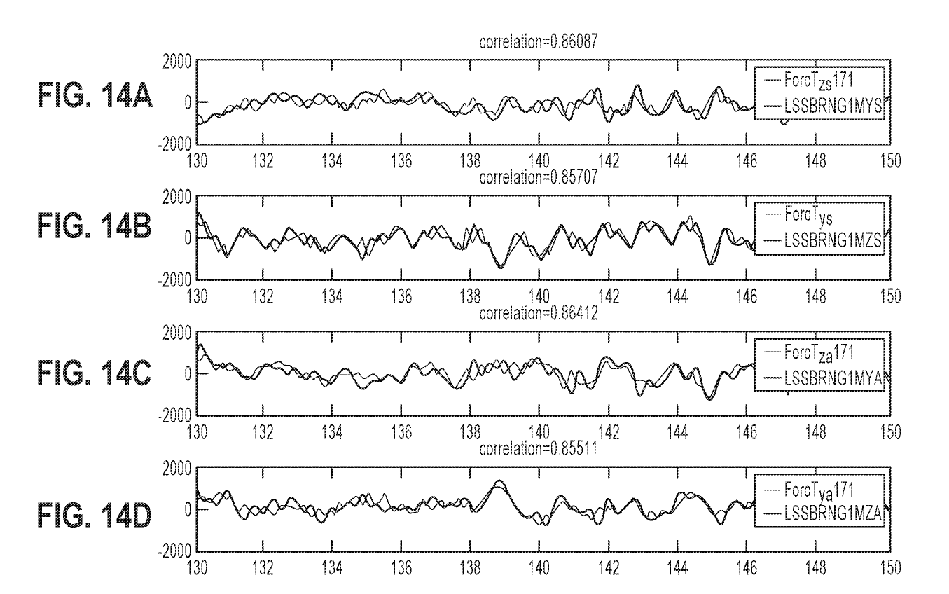

FIGS. 14A-14D illustrate example graphs showing the signals/values of the various measured (or estimated) bending moments and the four force quantities at the low-speed shaft bearing location. As can be seen, the two signals trace each other closely, which may indicate high correlation.

Taking into consideration the second-order relationship between F_{T} and Δp (discussed above), and the linear mapping between F_{T} and the low-speed shaft moments, a regression model may be determined to estimate/calculate low-speed shaft moments directly from the measured pressure differential measurements (Δp). For example, a second-order regression model may be expressed as the equation:

$${M}_{LSS} = {\sum }_{i = 0}^{2} {k}_{i} Δ {p}^{i} \qquad ( 29 )$$

where M_{LSS} represents the rotating/stationary low-speed shaft moment/load at the shaft tip, bearing, or flange locations, and kᵢ is a constant. According to some aspects, kᵢ may be estimated by minimizing the mean-squared error (MSE) between the estimated moments and the actual measurements.

According to some embodiments, a computing device may determine that the pressure differential measurements may be correlated to the local wind speed. In consideration of the pressure differential measurements being correlated to the normal force (F_{N}) along the blade elements, as discussed above, a computing device may determine a correlation between the normal force (F_{N}) and the local wind speed. For example, F_{N} may be expressed as:

$$\begin{matrix}{F}_{N} = L cos φ + D sin φ \\ = \frac{1}{2} {ρ}_{∞} {v}_{∞}^{2} \sqrt{1 + {λ}^{2}} ( {C}_{L} λ + {C}_{D} ) ( 31 )\end{matrix} \qquad ( 30 )$$

where ω represents the rotor speed, r represents the radial location, C_{L} represents the lift coefficient, C_{D} represents the drag coefficient, ρ_{∞}, represents the air density, ν_{∞} represents the local wind speed, q represents the local dynamic pressure, L represents the lift load, and D the drag load. λ may be assigned the value:

$$λ = {cot}^{- 1} ( φ ) = \frac{ω r}{{v}_{∞}} \qquad ( 32 )$$

For small angles of attack, it may be assumed that:

C_{L}=kₗα+bₗ and C_{D}=k_{d}α+b_{d} (33)

where α represents the angle of attack. Substituting C_{L} and C_{D} into the expression for F_{N} may produce:

F_{N}=½ρ_{∞}ν_{∞}²\sqrt{1+λ²}k₁(αλ+k₁λ+k₂α+k₃) (34)

where k₁=bₗ/kₗ, k₂=k_{d}/kₗ, and k₃=b_{d}/kₗ. In a simulation and/or testing environment, it may be observed that k₁, k₂, and k₃ can be approximated by 0, and

α=λ−β−θ (35)

with β representing the blade pitch and θ representing the blade twist. Accordingly, the following relationship may be determined:

F_{N}˜v_{∞}²λ\sqrt{1+λ²}(λ−β−θ) (36)

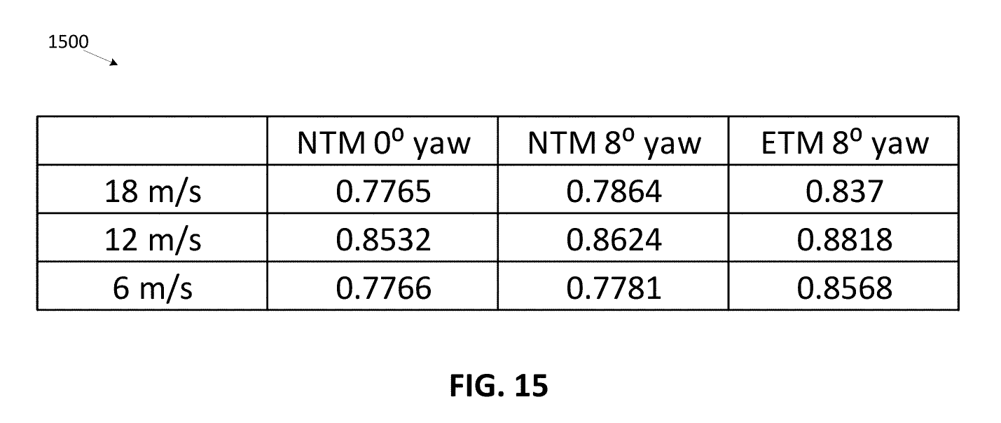

FIG. 15 illustrates an example graph 1500 showing the correlation coefficient values determined for measured and estimated F_{N}. Graph 1500 illustrates the correlation coefficient between the measured and estimated F_{N} under different wind conditions, at different yaw angles, and under different turbulence conditions (e.g., Normal Turbulence Model (NTM) and Extreme Turbulence Model (ETM)). As can be seen in FIG. 17, there may be a close correlation between the measured and estimated F_{N}.

According to some embodiments, turbine operation conditions and potential failures may be monitored during the operating life of a turbine. Such condition monitoring may be a major component of predictive maintenance techniques and may have the benefit of prolonging the life of the turbine, reducing overall maintenance cost, and reducing the turbine revenue losses. Pressure differential measurements (Δp) may provide valuable information for turbine condition monitoring.

According to some embodiments, a Fourier transform may be applied to the load signals, where the load signals may be determined based on pressure differential measurements. The Fourier transform of a load signal may result in one or more frequency components associated with the load signal. According to some aspects, abnormal behavior may be determined based on observing the frequency components of the load signals. For example, the Fourier transform of the low-speed shaft moment may have a normal/typical dominant or primary frequency component value (e.g., a natural frequency of 0.5 Hz). According to some aspects, abnormal behavior may be associated with a turbine or blade after the primary frequency component value deviates (e.g., more than a threshold value) from the typical primary frequency component value. For example, a blade may be associated with abnormal behavior if the primary frequency component value of the low-speed shaft moment deviates from 0.5 Hz to 0.6 Hz.

According to some embodiments, a computing device, such as a turbine controller device, may apply statistical process control to estimated load signals (e.g., determined based on pressure differential measurements as described herein) to determine abnormal events that may have occurred or may be occurring in a turbine. For example, a turbine controller may set control limits or thresholds for an estimated load. Such control limits may have a lower threshold and/or an upper threshold value for the estimated load (e.g., associated with normal operating conditions). According to some aspects, if the turbine controller determines that the estimated load is lower than a lower threshold value and/or higher than an upper threshold value for that specified load measurement, then the turbine controller may designate or identify the associated blade as having a possible problem. The turbine controller may designate or identify such an estimated load measurement as an outlier measurement. The blade may then be tested and/or inspected to determine whether the blade has a problem and what the cause may be.

According to some embodiments, a computing device, such as a turbine controller device, may use estimated load signals (e.g., determined based on pressure differential measurements as described herein) for fatigue estimation and prevention of turbine components, such as turbine blades. Fatigue estimation may include determining an estimation of the number of years (or other value, such as number of fatigue cycles) a blade or turbine has left in its useful life. For example, a blade may be initially designed or manufactured with an expected operation life of 20 years. After two years of operation, the blade may have an expected 18 years left of operational life.

According to some aspects, an estimation of a blade's age or the number of years a blade has left in the blade's useful life may be determined by plotting the blade's performance over an amount of time (e.g., 5 years) against a second blade's (e.g., on the same or different turbine) performance over another amount of time (e.g., 15 years). If the performance of the first blade matches or correlates to the performance of the second blade, then the first blade's operational life (or age) may be estimated to match or correlate to the life of the second blade. Thus, in the above example, the first blade's estimated operational life may be 15 years, even though the blade may have been only operated for 5 years. According to some aspects, a controller may use a database of characteristics of one or more turbines when performing the above determinations, calculations, and/or correlations. Thus, a controller may compare a blade's characteristics to a plurality of other blades' characteristics. According to some aspects, a blade's characteristics may be compared to fatigue test data, such as determined in a lab or in a controlled setting. In one example, patterns may be identified based on a blade's characteristics (e.g., loads) over a period of time and compared to templates that indicate a particular issue.

In some arrangements, fatigue estimation may be based on cycle counting and load estimation/determination. For a turbine blade, each load combined with each cycle may contribute to fatigue damage. According to some embodiments, the turbine controller may determine fatigue (e.g., a damage equivalent load for the blade) using a rain-flow cycle counting algorithm, which may be applied periodically using an estimated pressure differential measurement signal or load measurement signal. The controller may use rain-flow cycle counting to determine a damage equivalent load for a blade. The controller may then compare the damage equivalent load for that blade to a baseline damage equivalent load for that type of blade. For example, the controller may determine a ratio of the damage equivalent load for that blade to a baseline or design damage equivalent load for that type of blade, and that ratio may provide an estimation of the life left in the blade. For example, if after 5 years, the controller may determine the measured damage equivalent load in a blade to be 500. If the baseline or design damage equivalent load for that type of blade is 1000, then the controller may determine that half of the useful life of the blade may have been consumed. In another example, if an expected damage equivalent load for that type of blade is 350, the controller may determine that the blade will have a shorter life than expected. Accordingly, the controller may determine one or more characteristics of the blade (e.g., yaw, pitch, actuator deployment) to modify in order to reduce the damage equivalent load for the blade going forward so that the blade reaches its expected life or some other specified threshold amount of time.

According to some aspects, an estimation of a blade's age or the number of years a blade has left in the blade's useful life may be determined by identifying an issue associated with a blade. For example, if a turbine controller detects an outlier pressure differential measurement and/or determines a load value based on this outlier pressure differential measurement, then the turbine controller may determine that something may be wrong with the blade. Accordingly, the blade may be inspected to determine whether there is a problem with the blade, such as leading edge erosion in proximity to the pressure sensor device used to take the outlier measurement. The controller may then determine, based on the severity associated with the problem, a new operation age of the blade, which may actually be greater or less than the actual age of the blade (e.g., two years old). For example, because of the leading edge erosion, the controller may determine that the operation life of the blade may be 9 years old, and/or may determine the blade to only have 11 more years of useful operational life left. Thus, fatigue estimate may include determining how much life is left in a blade and describe the blade's performance. Thus, blade damage may be prevented by inspecting the blade after determining an outlier measurement.

According to some embodiments, a computing device, such as a turbine controller, may use pressure differential measurements and/or load measurements to determine whether a fault has occurred in a turbine. A fault may be a harmful event that occurs in or to a turbine. Faults may be catastrophic events that may have an instantaneous effect on a turbine or blade. A turbine controller may use fault estimation to determine whether an event has already occurred to a blade or turbine. For example, the turbine controller may receive measurements from a sensor (such as a pitch sensor) that may sense that a blade is outside of a normal pitch operating zone. The turbine controller may then determine that this may indicate that a harmful event has occurred. According to some aspects, the turbine controller may use pattern recognition techniques to estimate faults, either instead of or in addition to using, for example, a pitch sensor. For example, the turbine controller may determine that certain patterns in the pressure differential measurement signals (and/or load signals) may be associated with a pitch fault (or other fault, such as a yaw fault, etc.). The turbine controller may then, based on this detected pitch fault, slow down the rotor in preparation of the turbine's brake. In another example, the comparison of the loads on a blade could provide an indication of an abnormal event, such as a pitch error or offset of the blade. According to some aspects, if the controller determines that there is a significant change in the measured loads from the expected loads (e.g., by comparison to historical blade measurements for the blade, blade-to-blade comparisons, etc.), then the controller may determine that a blade abnormality or problem may have occurred. These blade problems may be acute (e.g., occurring abruptly) or may be chronic (e.g., occurring over a period of time). These blade problems may also vary in the degree of severity. For example, a tower strike may be an acute and/or a severe problem, a blade pitch offset may be acute or chronic and/or may range from a not very severe to a very severe problem, and blade erosion may be chronic and/or a less severe problem. According to some aspects, for acute and/or severe problems, the controller may slow or shutdown the turbine immediately (e.g., within a few minutes, hours, or days after noticing the problem, etc.). According to some aspects, for chronic and/or less severe problems, the controller may slow or shutdown the turbine at a next convenient time (e.g., at the next 3 or 6 month interval, etc.). The blade may then be inspected for any problems. Such preventative maintenance may have the potential to prolong the turbine's life.

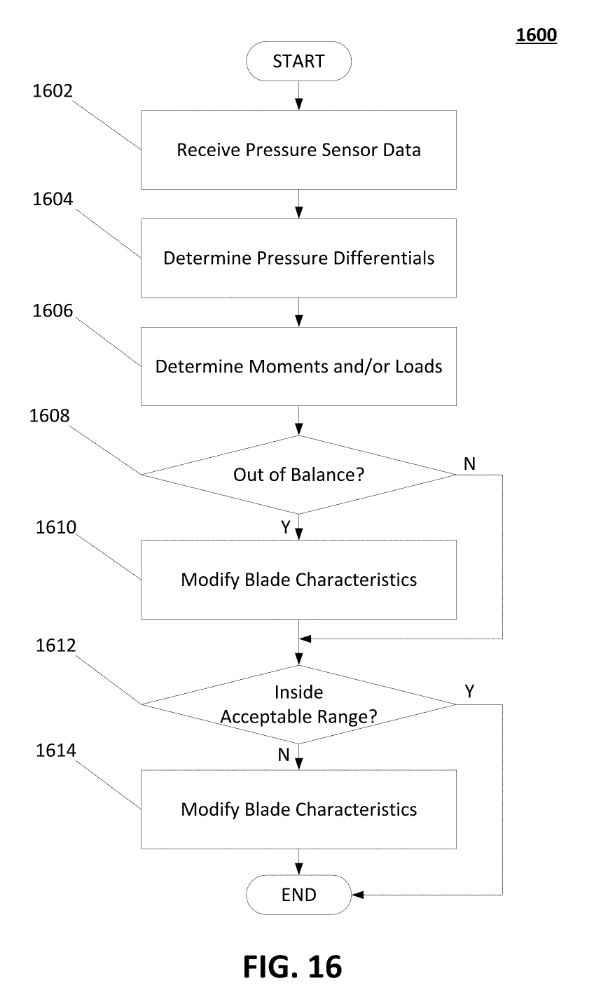

FIG. 16 illustrates a flowchart 1600 of an example method for optimizing and/or balancing blades of a wind turbine. At step 1602, pressure sensor data is determined by a control system. Pressure sensor data may be determined (e.g., received, calculated, measured, etc.) from a one or more pressure sensors on one or more blades. At step 1604, pressure differentials may be determined from the received pressure sensor data. For example, each pressure sensor may include a pressure orifice on the bottom surface of a blade and a pressure sensor orifice on a top surface of a blade (such as P₁ and P₂ in FIG. 2). The system, at step 1604 may thus determine a difference in pressure between these two orifices which, as presented above, may be proportional to loads and/or moments the blade is experiencing. Alternatively or additionally, at step 1904, the system may determine other values (e.g., discussed above) that may be needed to calculate, determine, and/or estimate loads and/or moments.

At step 1606, these loads and/or moments may be determined using, for example, any of the aforementioned methods, equations, and/or relationships. In some embodiments, other characteristics, such as forces associated with a blade, in addition to pressure differential may be used to determine loads and/or moments. For example, the system may use one or more of the rotor speed of the wind turbine, barometric (i.e., ambient air) pressure, ambient air temperature, a sensor radial location, a twist angle of the wind turbine blade, and/or a pitch angle of the wind turbine blade in determining loads and/or moments acting on the blade.

At step 1608, the system may determine whether the loads and/or moments are out of balance. For example, in one embodiment the loads and/or moments experienced by one of the wind turbine blades may be compared to the loads and/or moments experienced by other wind turbine blades. If the loads and/or moments experienced by the first blade are out of balance with the loads and/or moments experienced by other blades, the method may proceed to step 1610. If, however, the loads and/or moments are not out of balance, the system may proceed to step 1612. At step 1610, the blade may be inspected and/or characteristics of the blade may be modified in order to bring the load acting on a first blade back in balance. For example, if the blade is equipped with a deployable air deflector, the method may deploy the air deflector. Additionally or alternatively, the method may change the pitch angle of the blade or the yaw angle of the turbine and/or blade to balance the loads and/or moments. Or the method may extend or retract a tip portion of the blade. Any modification at this step may be made in real-time while the wind turbine is rotating or during a turbine down state. Accordingly, the method may bring blades into balance while the wind turbine is operating to avoid, for example, downtime and lost productivity.

The system may also determine whether determined loads and/or moments are within an acceptable range at step 1612. For example, the system may determine the loads and/or moments acting on a blade are too high, and accordingly may modify any of the abovementioned characteristics in response at step 1614 in order to avoid damage to the blade. Again, any modification at step 1614 may be made in real time to avoid, for example, downtime and lost productivity, or during a turbine down state. The process may then end.

According to some aspects, for any of the aforementioned techniques and processes, a control system for a wind turbine may derive many useful metrics used in the control of the wind turbine by merely estimating loads and/or moments associated with at least one blade of the turbine. Such a control system may be used to modify characteristics of the turbine. For example, if the root bending moment is too high, a control system may alter one or more characteristics to reduce the moment and thus avoid damage to the rotor and/or the blades. Additionally, if the root bending moment is too low, a control system may alter one or more characteristics to increase the moment in order to, for example, increase power generation.

We claim:

1. A method comprising:
determining, by a control device, at least one pressure differential on turbine blade, each pressure differential being determined between a respective first pressure location on the blade and a respective second pressure location on the blade; and
based on the at least one determined pressure differential, determining, by the control device, a moment generated by a force acting on the blade.

2. The method of claim 1, wherein the moment is determined via an artificial neural network.

3. The method of claim 2, further comprising:
determining a number of one or more inputs to the artificial neural network based on the at least one pressure differential;
configuring the artificial neural network with one or more neurons;
providing the one or more inputs to the one or more neurons to determine, for each neuron, a weight and a bias value associated with the one or more inputs; and
determining, based on a transfer function associated with the artificial neural network, the determined moment.

4. The method of claim 2, further comprising:
measuring the at least one pressure differential at a first time;
training the artificial neural network using the at least one pressure differential based on a minimization algorithm, the minimization algorithm minimizing the difference between a target moment and a moment output by the artificial neural network associated with the measured at least one pressure differential at the first time, wherein the training comprises: modifying a neuron associated with the artificial neural network, a weight associated with the at least one pressure differential, a bias associated with the at least one pressure differential, or a combination thereof; and
determining another moment associated with the blade at a second time subsequent to the first time.

5. The method of claim 1, further comprising modifying at least one characteristic of the blade in response to determining the moment generated by the force acting on the blade.

6. The method of claim 5, wherein the modifying the at least one characteristic of the blade comprises at least one of: changing a pitch angle of the blade, changing a yaw angle of a rotor, deploying at least one air deflector, retracting the at least one air deflector, extending a tip portion of the blade, and retracting the tip portion of the blade.

7. The method of claim 5, further comprising increasing or decreasing the moment generated by the force acting on the blade by performing the modifying.

8. The method of claim 1, further comprising:
determining a first load acting on the blade based on the at least one pressure differential;
determining a second load acting on another blade based on at least one other pressure differential, the at least one other pressure different determined based on a first pressure sensing location on the other blade and a second pressure sensing location on the other blade; and
determining a low-speed shaft moment of a turbine to which the blade and other blade are attached based on the determined first and second loads.

9. The method of claim 1, wherein the moment generated by the force acting on the blade is determined via a regression model based on the determined at least one pressure differential.

10. The method of claim 1, wherein determining the moment generated by the force acting on the blade is performed based on a multi-blade coordinate transformation associated with the blade.

11. The method of claim 10, further comprising:
determining a tangential aerodynamic force associated with the blade based on the at least one pressure differential;
determining, via the multi-blade coordinate transformation, at least one related force value based on the tangential aerodynamic force and a quantity of blade elements along the blade; and
determining the moment generated by the force acting on the blade based on the at least one related force value.

12. The method of claim 10, further comprising determining the moment generated by the force acting on the blade in at least one of a rotating plane of the blade and a stationary plane of the blade.

13. The method of claim 1, further comprising determining the moment at one or more of the following locations: a root portion of the blade, a shaft tip of a low speed shaft, a flange of the blade, and a bearing of the blade.

14. The method of claim 1, further comprising:
determining a normal force of the blade at the first pressure location or the second pressure location; and
determining, by the control device and based on the determined normal force, a local wind speed at the first pressure location or the second pressure location.

15. A method comprising:
determining, by a turbine control device, a pressure differential on a blade, the pressure differential being determined between a first pressure location on the blade and a second pressure location on the blade;
determining, by the turbine control device, a load on the blade based on the pressure differential at the plurality of times;
determining, by the turbine control device, a number of times the load on the blade exhibits a specified characteristic;
comparing, by the turbine control device, the number of times the load on the blade exhibits the specified characteristic with an expected value; and
modifying, by the turbine control device, at least one operating characteristic of the blade based on a result of the comparison.

16. The method of claim 15, further comprising:
determining an operational age of the turbine blade based on the determined loads, wherein the expected number is an expected operational age.

17. The method of claim 16, wherein the at least one operating characteristic includes at least one of a pitch and a yaw of the blade.

18. The method of claim 16, wherein the at least one operating characteristic includes a deployment of an air deflector from a surface of the blade.

19. The method of claim 15, further comprising determining a leading edge erosion at a spanwise location of the blade proximate to the first and second pressure sensing locations.

20. The method of claim 15, further comprising:
determining a moment resulting from the load on the blade; and
comparing the moment to the expected value, wherein the expected value comprises a threshold moment.

21. The method of claim 20, wherein determining the moment is performed using a regression model or an artificial neural network.

22. The method of claim 20, wherein the moment comprises at least one of: a root bending moment of the blade and a low-speed shaft moment.

23. The method of claim 15, wherein the specified characteristic includes the load being outside of a specified range of load.

24. The method of claim 15, wherein determining the number of times the load on the blade exhibits the specified characteristic is performed using a rain-flow cycle counting algorithm.

25. A method comprising:
determining, by control device, one or more pressure differentials on rotor blade of a turbine, each pressure differential being determined between a respective first pressure location on the blade and a respective second pressure location on the blade;
identifying, by the control device using a pattern recognition technique and based on the one or more pressure differentials, a first pattern associated with the one or more pressure differentials; and
determining, by the control device, a fault associated with at least one of the rotor blade and the turbine based on the first pattern.

26. The method of claim 25, wherein identifying the first pattern associated with the one or more pressure differentials comprises:
determining, based on the one or more pressure differentials, one or more moments associated with the at least one of the rotor blade and the turbine; and
identifying, by the control device using a pattern recognition technique and based on the one or more pressure differentials, a pattern associated with the at least one of the rotor blade and the turbine.

27. The method of claim 26, wherein determining the one or more moments with the at least one of the rotor blade and the turbine comprises determining the one or more moments via a regression model or via an artificial neural network.

28. The method of claim 26, wherein the one or more moments with the at least one of the rotor blade and the turbine comprises a root bending moment of the rotor blade or a low-speed shaft moment.

29. The method of claim 25, wherein the determined fault includes the blade being outside of a normal pitch or yaw operating zone.

30. The method of claim 25, wherein the determined fault relates to the blade and wherein the method further comprises modifying a motion associated with the blade based on the determined fault.

31. The method of claim 25, wherein identifying the first pattern associated with the one or more pressure differentials comprises wherein identifying a pattern associated with frequency components of a signal associated with the one or more pressure differentials, the frequency components being determined via a Fourier transform.
